(19) United States
(12) Patent Application Publication
(10) Pub. No.: US 2026/0301242 A1
(43) Pub. Date: Oct. 1, 2026

(54) MULTI-CAMERA WEARABLE AUGMENTED REALITY DEVICE WITH MULTIMODAL EYE TRACKING

(71) Applicants: VIRGINIA TECH INTELLECTUAL PROPERTIES, INC., Blacksburg, VA (US); Montclair State University, Montclair, NJ (US)

(72) Inventors: Matthew Corbett, Christiansburg, VA (US); Brendan Matthew David- John, Blacksburg, VA (US); Jiacheng Shang, Secaucus, NJ (US); Bo Ji, Blacksburg, VA (US)

(21) Appl. No.: 19/572,169

(22) Filed: Mar. 19, 2026

Related U.S. Application Data
(60) Provisional application No. 63/777,250, filed on Mar. 25, 2025.

(51) Int. Cl. G06T 11/00; G06F 3/01; G06T 7/70; G06V 20/20; G06V 20/52; G06V 40/18

(52) U.S. Cl. CPC G06T 11/00; G06F 3/013; G06T 7/70; G06V 20/20; G06V 20/52; G06V 40/18; G06T 2207/30196

(57) ABSTRACT

Multi-camera wearable augmented reality (AR) devices with multimodal eye tracking are described. An example wearable AR device includes one or more cameras positioned to obtain first images of eyes of a user of the wearable AR device, and one or more rear-facing cameras positioned to obtain second images behind the user. The wearable AR device also includes processing circuitry to track a gaze of the user based on the first images from the one or more cameras, determine a gaze of a potential shoulder surfing attack (SSA) threat based on the second images from the one or more rear-facing cameras, determine whether there is an overlap in the gaze of the user and the gaze of the potential SSA threat, and provide an alert to the user based on determining that there is the overlap.

### CROSS-REFERENCE TO RELATED APPLICATIONS

This application claims priority under 35 U.S.C. § 119(e) to Provisional Patent Application No. 63/777,250, filed Mar. 25, 2025, the entire contents of which are hereby incorporated herein by reference.

### BACKGROUND

Augmented reality (AR) refers to the overlay of computer-generated content on a real-world environment. In a vehicle, for example, an AR navigation system may project an image of an arrow on the windshield so that it is overlaid on the real-world view of a road, indicating an upcoming turn. Wearable AR devices (e.g., smart glasses, head-mounted displays) are gaining popularity for navigation, translation, gaming (e.g., without the need for a phone screen or monitor), to take photos or video without holding a device, and a number of other functions.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Various embodiments are disclosed for multi-camera wearable augmented reality (AR) devices with multimodal eye tracking. An example wearable AR device includes one or more cameras positioned to obtain first images of eyes of a user of the wearable AR device and one or more rear-facing cameras positioned to obtain second images behind the user. The wearable AR device also includes processing circuitry to track a gaze of the user based on the first images from the one or more cameras, determine a gaze of a potential shoulder surfing attack (SSA) threat based on the second images from the one or more rear-facing cameras, determine whether there is an overlap in the gaze of the user and the gaze of the potential SSA threat, and provide an alert to the user based on determining that there is the overlap.

In some aspects, the wearable AR device is an AR headset and the one or more rear-facing cameras comprises one rear-facing camera affixed to a headband of the AR headset. The one rear-facing camera may be a wide-angle camera with a field of view covering an angular width of at least 80 degrees. In some aspects, the wearable AR device is AR glasses and the one or more rear-facing cameras comprises a first rear-facing camera affixed to one of two temples of the AR glasses and a second rear-facing camera affixed to another temple of the AR glasses. Fields of view of the first rear-facing camera and the second rear-facing camera may overlap and cover an angular width of at least 80 degrees.

In some aspects, the processing circuitry implements visual simultaneous localization and mapping (SLAM) processes on the first images from the one or more cameras and on the second images from the one or more rear-facing cameras to track the gaze of the user and the gaze of the potential SSA threat in a common three-dimensional reference frame. The processing circuitry may determine whether there is the overlap in the gaze of the user and the gaze of the potential SSA threat based on a threshold distance. The processing circuitry may omit determining whether there is the overlap based on the potential SSA threat being designated as not being a threat by the user. The processing circuitry may provide the alert to the user as content overlaid on a lens of the wearable AR device. The content may comprise an arrow pointing in a direction of the potential SSA threat.

An example method implemented by a wearable augmented reality (AR) device includes obtaining first images of eyes of a user of the wearable AR device with one or more cameras and obtaining second images behind the user with one or more rear-facing cameras. The method also includes tracking a gaze of the user based on the first images obtained from the one or more cameras, determining a gaze of a potential shoulder surfing attack (SSA) threat based on the second images obtained from the one or more rear-facing cameras, determining whether there is an overlap in the gaze of the user and the gaze of the potential SSA threat, and providing an alert to the user based on determining that there is the overlap.

In some aspects, the wearable AR device is an AR headset and obtaining the second images from the one or more rear-facing cameras comprises obtaining the second images from one rear-facing camera affixed to a headband of the AR headset. Obtaining the second images from the one rear-facing camera may include obtaining the second images from a wide-angle camera with a field of view covering an angular width of at least 80 degrees. In some aspects, the wearable AR device is AR glasses and obtaining the second images from the one or more rear-facing cameras comprises obtaining the second images from a first rear-facing camera affixed to one of the temples of the AR glasses and a second rear-facing camera affixed to another temple of the AR glasses. Fields of view of the first rear-facing camera and the second rear-facing camera may overlap and cover an angular width of at least 80 degrees.

In some aspects, the method also includes implementing visual simultaneous localization and mapping (SLAM) processes on the first images from the one or more cameras and on the second images from the one or more rear-facing cameras to track the gaze of the user and the gaze of the potential SSA threat in a common three-dimensional reference frame. Determining whether there is the overlap in the gaze of the user and the gaze of the potential SSA threat may be based on a threshold distance. In some aspects, the method may also include omitting determining whether there is the overlap based on the potential SSA threat being designated by the user as not being a threat. Providing the alert to the user may include overlaying content on a lens of the wearable AR device. Overlaying content may include overlaying an arrow pointing in a direction of the potential SSA threat.

### BRIEF DESCRIPTION OF THE DRAWINGS

Many aspects of the present disclosure can be better understood with reference to [the following drawings. The components in the drawings are not necessarily to scale, with emphasis instead being placed upon clearly illustrating the principles of the disclosure. Moreover, in the drawings, like reference numerals designate corresponding parts throughout the several views. Repetition of labels for some components may be omitted for clarity of the illustrations.

FIG. 1 shows aspects of a wearable augmented reality (AR) device in the form of an AR headset according to various exemplary embodiments.

FIG. 2 shows aspects of a wearable AR device in the form of AR glasses according to various exemplary embodiments.

FIG. 3 is a top-down illustration of a user wearing the AR headset shown in FIG. 1.

FIG. 4 is a top-down illustration of a user wearing the AR glasses shown in FIG. 2.

FIG. 5 is a process flow of a method implemented by processing circuitry of a wearable AR device 10 according to various embodiments.

FIG. 6 is a block diagram detailing aspects of the processing circuitry of a wearable AR device according to various embodiments.

### DETAILED DESCRIPTION

As noted above, AR technology includes projection-based AR (e.g., on windshields), as well as wearable devices (e.g., AR glasses, head-mounted displays), which can project content on the lenses or headset and/or in space. Wearable AR devices have a number of existing applications. For example, information, instructions, or images may be overlaid on a real-world view to aid in aviation, medicine, and industrial applications. AR glasses may be used to overlay navigation instructions on the real-world view through the lenses so that another device (e.g., handheld phone) does not have to be consulted. Images may be obtained with a camera integrated with AR glasses. The images may be used to look up information about objects visible in those images (e.g., operating hours of a store, a variety of plant), for example.

In this context, multi-camera wearable AR devices with multimodal eye tracking are described. Embodiments of the multi-camera wearable AR devices may be used for privacy and/or security applications, as described herein. According to various embodiments, the multi-camera AR devices include at least one rear-facing camera with a field of view that may cover areas not visible to the wearer of the AR device, referred to herein as the user. Thus, in some embodiments, the wearable AR device may facilitate monitoring for a security threat (e.g., being followed).

The application may be context-dependent and may be activated by a user in specific scenarios such as when walking in an isolated area or in a secure area in which no one should be behind the user. The user may select detection of an object (e.g., vehicle) rather than a person based on the context (e.g., when riding a bicycle). A message or captured image of the person or vehicle following may be displayed to the user of the wearable AR device. Additionally or alternately, an audible or haptic alert may be issued to provide situational awareness to the user.

According to various embodiments, the multi-camera wearable AR device may include a camera that captures the user's eyes and one or more additional cameras that capture the gaze of those outside the user's field of view. Thus, in some embodiments, the wearable AR device may provide an alert to the user about a potential shoulder surfing attack (SSA). An SSA refers to a type of cybersecurity breach involving a person who surreptitiously views the victim's device screen or keypad to obtain a pin or password.

Prior approaches to thwarting SSAs include both passive and active techniques. Passive approaches refer to those that aim to obscure information entered by the user to reduce the chance of a potential attacker obtaining private information. These techniques are typically device-specific. That is, an automated teller machine (ATM) or other code entry device (e.g., at a door) may facilitate using eye gaze, eye gesture, or other eye movement-based entry of a code, rather than a touchpad or button entry that may be more easily observed. As other examples, pin entry format may be changed for each user so that observing a user's finger movement may not yield a repeatable procedure to gain access. The pin itself may be changed from a single series of numbers to a pattern of images or the like that may be displayed in different locations each time. In some examples, physical barriers may be included to obscure an observer's view of the user's selection. A multimodal passive approach may combine two or more techniques. However, because these approaches are device specific, they must be implemented for each pin pad or touch screen separately.

Active approaches to defending against SSAs refer to techniques for detecting a potential attacker. A simple example is a mirror at an ATM so that a user may catch someone peering over their shoulder during pin entry. Other active approaches may be digital analogs to the mirror. For example, many ATMs have a camera facing the user and can capture someone behind the user, as well. However, like the passive approaches noted above, these techniques are device specific. Thus, a user must rely on the facility (e.g., ATM, secured building) to incorporate one or more passive and/or active approaches.

Additionally, a device specific approach to SSA does not address the increased use of user devices for private and confidential use. It is increasingly common for a user to access banking, medical, and other personal information by employing an application on a mobile device (e.g., smart phone, laptop, tablet). In addition, an SSA may expose client information or other confidential information as people work in airports, cafes, and other public locations. Thus, not only passwords and pins, but also private and confidential information is vulnerable to SSA when entered on a user device or other device that may not employ one of the passive or active techniques noted above.

According to various embodiments, a multi-camera wearable AR device with multimodal eye tracking facilitates SSA detection in a user specific, rather than a device specific, manner. Thus, a user may be alerted to a potential SSA, regardless of where or when it occurs. Multimodal eye tracking refers to the fact that eye gaze is detected for the user and, additionally, the gaze of people around the user who may not be in the field of view of the user is also detected and monitored. Fixation duration, which indicates the duration of the user's gaze and can act as a proxy for visual attention, can facilitate determining when the user is looking at a pin pad, touchscreen, phone screen, monitor, or other device of interest in SSA detection.

The multi-camera wearable AR device can, therefore, use multimodal eye tracking to determine the potential for an SSA and alert the user as needed. While a multi-camera wearable AR device for determination of a potential SSA is specifically discussed for explanatory purposes, the security functionality is mentioned for each of the exemplary systems, as well. That is, the exemplary AR devices discussed herein for SSA determination may be used for security functions based on the features and components discussed, or even based on fewer components than those needed for SSA determination.

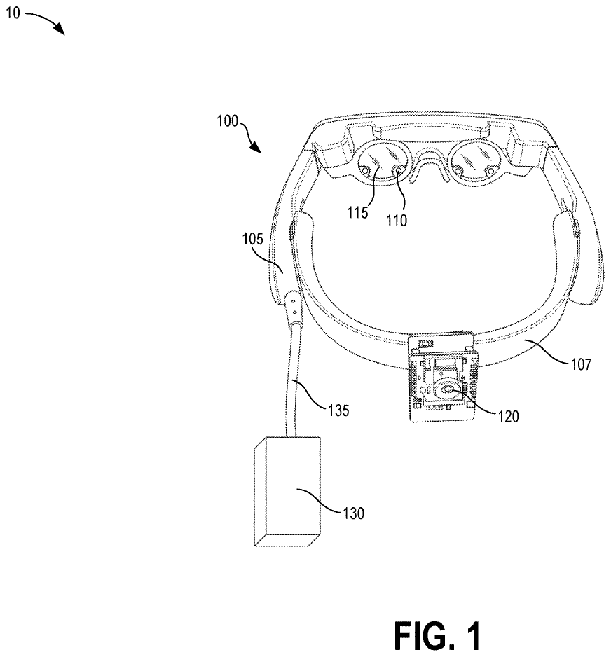

Turning to the drawings, FIG. 1 shows aspects of a wearable AR device 10 in the form of an AR headset 100 according to various exemplary embodiments. The AR headset 100 includes cameras 110 that capture images of the user's eyes. In the illustrated example, two cameras 110 are shown associated with each lens 115. One rear-facing camera 120 is shown affixed to a headband 107 of the AR headset 100. The rear-facing camera 120 may be a wide-angle camera, for example.

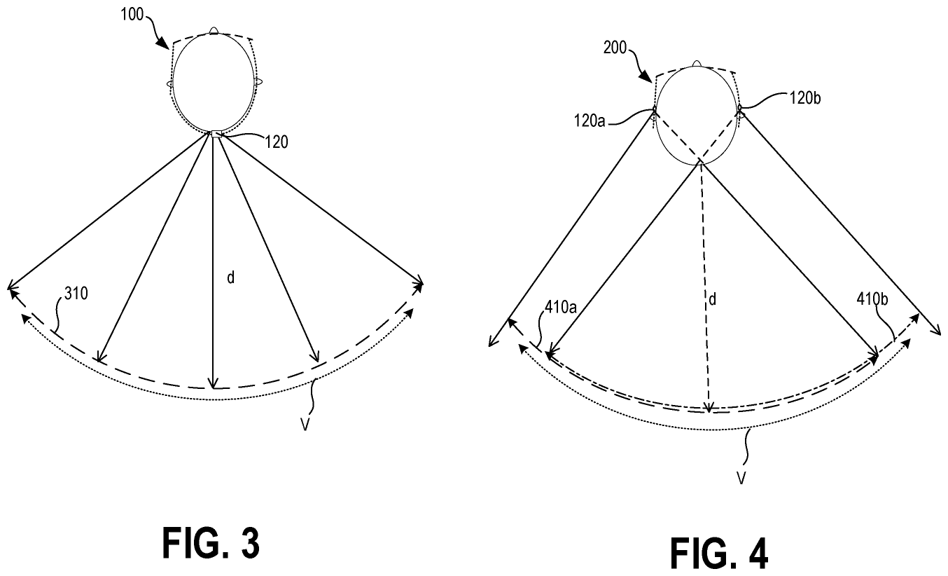

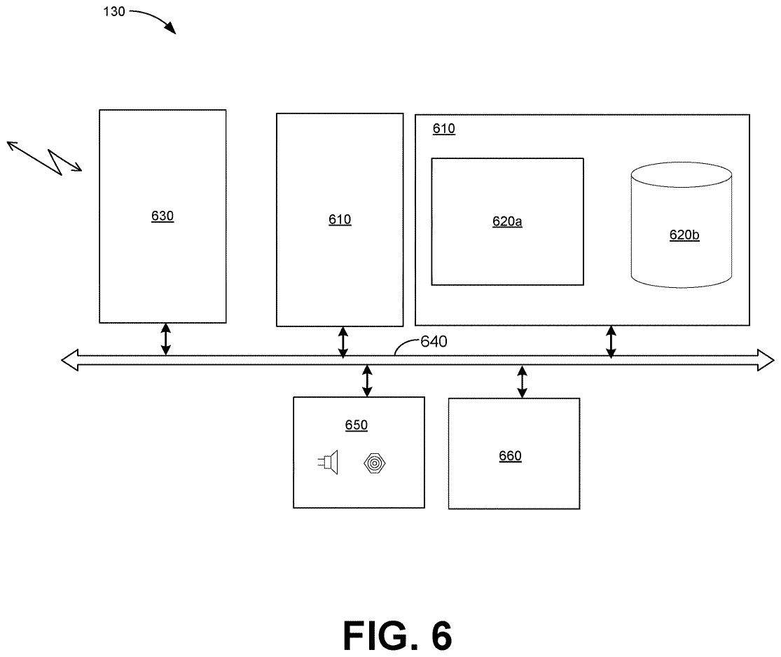

As discussed with reference to FIG. 3, the rear-facing camera 120 may have a field of view (FOV) that facilitates imaging people behind the user who may mount an SSA. Processing circuitry 130 is shown connected to the AR headset 100 via a wire 135. The wire is shown extending from one of the arms of the AR headset 100, referred to as a temple 105. Aspects of the processing circuitry 130 are further discussed with reference to FIG. 6. In some embodiments, one or both temples 105 may also include components of the processing circuitry 130.

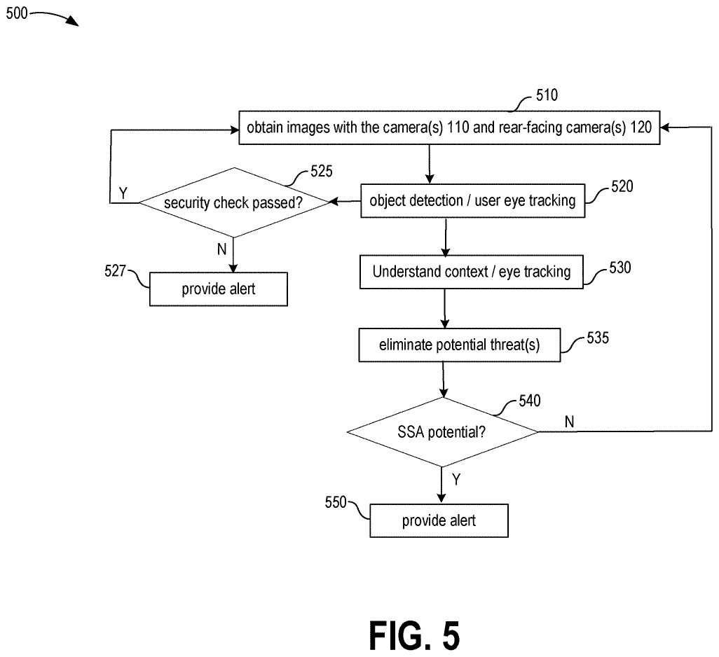

One rear-facing camera 120 is shown affixed to a headband 107 of the AR headset 100. As discussed with reference to FIG. 3, this rear-facing camera 120 may have a field of view (FOV) that facilitates imaging people behind the user who may mount an SSA. Processing circuitry 130 is shown connected to the AR headset 100 via a wire 135. The wire is shown extending from one of the arms of the AR headset 100, referred to as a temple 105. Aspects of the processing circuitry 130 are further discussed with reference to FIG. 5. In some embodiments, one or both temples 105 may also include components of the processing circuitry 130. In addition, aspects of the processing circuitry 130 may be accessed wirelessly rather than being attached via the wire 135.

Generally, the cameras 110 are used to monitor the gaze and fixation duration of the user. The rear-facing camera 120 is used to monitor the gaze of one or more people in the FOV of the rear-facing camera 120, and the processing circuitry 130 is used to determine whether there is a potential for an SSA. If the processing circuitry 130 determines the potential for an SSA, it may alert the user. The alert may be visual (e.g., text or an image or icon may be displayed as an augmented image on one or both lenses 115). Additionally or alternately, the alert may be auditory or haptic. The user may select one or more types of alerts.

While warning about a potential SSA can be regarded as a privacy function, the wearable AR device 10 (e.g., AR headset 100) may alternately or additionally be used for a security function, as previously noted. The AR headset 100 may increase situational awareness by warning that a person or vehicle is in the FOV of the rear-facing camera 120 or that the same person has been in the FOV of the rear-facing camera 120 for more than a predefined threshold duration of time, for example. What is detected (e.g., person, vehicle) and whether presence alone or duration of a presence are used for a warning may be situation dependent and may be set by a user. The cameras 110 and gaze detection may not be needed for the security features. Alternately, one or more cameras 110 may be forward facing to help determine the location of the user.

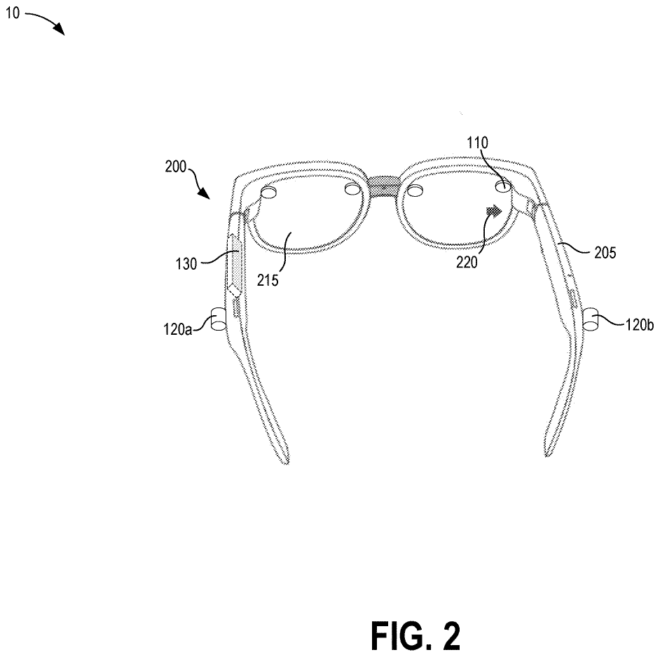

FIG. 2 shows aspects of a wearable AR device 10 in the form of AR glasses 200 according to various exemplary embodiments. The AR glasses 200 include cameras 110 that capture images of the user's eyes. In the illustrated example, two cameras 110 are shown at the top of each lens 215. The cameras 110 may be at the bottom of the lenses 215, as show in the exemplary illustration of the AR headset 100 in FIG. 1. In addition, in both the AR headset 100 and the AR glasses 200, one or more than two cameras 110 may be associated with each of the lenses 115, 215.

Two rear-facing cameras 120a, 120b (generally referred to as rear-facing camera(s) 120) are shown, each affixed to a corresponding temple 205 of the AR glasses 200. As discussed with reference to FIG. 3, the rear-facing cameras 120 may have a combined FOV that facilitates imaging people behind the user who may mount an SSA. Processing circuitry 130 is shown within one of the temples 205 of the AR glasses 200. Aspects of the processing circuitry 130, which is further discussed with reference to FIG. 6, may also be distributed within the other temple 205 or outside the AR glasses 200. The potential SSA detection and/or security functions discussed for the AR headset 100 in FIG. 1 are also possible with the AR glasses 200, as further discussed.

An exemplary visual alert 220 is shown in the form of an arrow in FIG. 2. The visual alert 220 may be overlaid on one of the lenses 215 (or one of the lenses 115 in the case of the AR headset 100). As discussed with reference to FIG. 5, the visual alert 220 may indicate the direction of a potential SSA threat (i.e., which shoulder a potential SSA attacker is looking over). As also discussed, audio or haptic alerts may alternately or additionally be provided. This may entail an output component 650 (e.g., speaker, vibrator) being included in one of the temples 205 (or one of the temples 105 in the case of the AR headset 100).

FIG. 3 is a top-down illustration of a user wearing the AR headset 100 shown in FIG. 1. A typical user may have a direct and peripheral FOV that spans 290 degrees. This leaves 70 degrees behind the user as a vulnerable zone, indicated by V. The rear-facing camera 120 affixed to the headband 107 is shown with an FOV 310. This FOV 310 may cover 80 degrees behind the user (i.e., an angular width greater than the 70 degree span of the vulnerable zone V). The distance d may be on the order of 2 meters. That is, the rear-facing camera 120 may process information about one or more people in an area behind the user that covers approximately 80 degrees and extends approximately 2 meters from the rear-facing camera 120.

FIG. 4 is a top-down illustration of a user wearing the AR glasses 200 shown in FIG. 2. As shown in FIG. 2 two rear-facing cameras 120a, 120b may be positioned near or above the user's ears, affixed to temples 105 of the AR glasses 200. The FOV 410a of one of the rear-facing cameras 120a and the FOV 410b of the other rear-facing camera 120b are shown. Each of the rear-facing cameras 120a, 120b may have a narrower but slightly longer FOV 410a, 410b (generally referred to as fields of view 410) as compared with the FOV 310 of the rear-facing camera 120 of the AR headset 100, as shown in FIG. 3. Together, the rear-facing cameras 120a, 120b may cover the vulnerable zone, indicated by V (i.e., angular width of at least 70 degrees behind the user), and an area behind the user that covers at least 80 degrees and extends at least 2 meters from the rear-facing cameras 120.

FIG. 5 is a process flow of a method 500 implemented by processing circuitry 130 of a wearable AR device 10 (e.g., AR headset 100, AR glasses 200) according to various embodiments. The flow associated with exemplary security functions are discussed first. At 510, obtaining images with the camera(s) 110 and rear-facing camera(s) 120 may include the camera(s) 110 facing forward rather than obtaining images of the user's eyes. One rear-facing camera 120 may be used, as shown for the AR headset 100 in FIG. 1, or two rear-facing cameras 120a, 120b may be used, as shown for the AR glasses 200 in FIG. 2. In alternate embodiments, more than two rear-facing cameras 120 may be used. When two or more rear-facing cameras 120 are used, their fields of view 410 may overlap, as shown for FOV 410a, 410b in FIG. 4 and their images may be used together.

At 520, performing object detection may involve image matching or image processing to identify a person, a vehicle, or another selected object. At 525, determining whether the security check is passed may entail determining whether an object of interest (e.g., person, vehicle, other selected object) is detected (at 520) in the images (collected at 510). If the object of interest is detected, the check at 525 determines that the security check is not passed. In this case, the processes include providing an alert to the user at 527. The alert may be visual (e.g., AR content overlaid on one or more lenses 115, 215), audible, haptic, or a combination of these.

If the object of interest is not detected, the check at 525 determines that the security check is passed. In this case, images may continue to be collected (at 510), and the processes at 510, 520, and 525 may be repeated periodically, for example. Alternately, the processes at 510 and 520 may be performed continuously, and the check at 525 may be triggered by the detection of an object of interest in one of the images obtained by the rear-facing camera(s) 120.

The flow associated with exemplary privacy functionality (e.g., potential SSA detection) also involves obtaining images (at 510) with the camera(s) 110 and rear-facing camera(s) 120. In this case, the camera(s) 110 obtain images of the user's eyes. At 520, the form of object detection relevant to the SSA detection involves tracking the user's eyes based on images from the camera(s) 110 and detecting one or more people in the images from the rear-facing camera(s) 120.

The user's location and head pose (e.g., roll, pitch, yaw) associated with each obtained image from the camera(s) 110 can be known from the metadata of the wearable AR device 10. Eye tracking may involve known approaches to track the user's eyes and obtain a frame of reference. For example, aspects of visual simultaneous localization and mapping (SLAM) processes may be employed to extract features (e.g., iris, pupil) of the user's eyes for tracking in a three-dimensional (3D) reference space. The visual SLAM processes may be used to update the 3D reference frame associated with the user as the user's position and head pose change.

The eye tracking of the user (at 520) facilitates determining fixation duration. As previously noted, determining fixation duration can indicate whether the user may be in a scenario susceptible to an SSA (e.g., looking at a pin pad, touch screen, phone screen, laptop) or not. The fixation duration may be compared with a threshold duration to identify an SSA susceptible scenario (e.g., fixation duration exceeds the threshold duration). Fixation duration may be determined in conjunction with eye tracking (at 520) for the user and may be used at the check at 540, as described below.

At 530, the processes include understanding context and performing eye tracking for anyone detected in the images obtained (at 510) from the rear-facing camera(s) 120. Context refers to the head pose of the user and the 3D reference space (from 520). The context is necessary to determine whether the user and one or more people captured in images from the rear-facing camera(s) 120 are looking in the same location. With the information determined for the user (at 520) indicating where the user is looking, an inference model may be used detect one or more people in images obtained by the rear-facing camera(s) 120 at the same times and to determine where the one or more people are looking.

One or more machine learning models may be used to identify one or more faces in the images obtained with the rear-facing camera(s) 120 and perform eye tracking in a common reference frame as the eye tracking for the user (at 520). A facial detection model may be used to identify one or more faces, as well as their iris or pupil position or other information indicating gaze direction. The rotation and local position of each identified face may be translated to the 3D reference frame determined for the user (at 520). Machine learning models that implement these translation processes may be referred to as perspective-n-point (PnP) inference models.

Aspects of visual SLAM processes may be implemented on images from the rear-facing camera(s) 120 to track the gaze of each person detected in the rear-facing camera(s) 120 in the 3D reference frame established for the user (at 520). Through the various processes implemented at 530, using one or more machine learning models, the gaze of one or more people captured in images from the rear-facing camera(s) 120 (i.e., one or more potential SSA threats) can be tracked in the same 3D reference frame as the eyes of the user.

At 535, additional optional processes may be implemented based on the facial detection (at 530) to eliminate certain people as potential SSA threats. This elimination may be done in real-time or based on a stored set of images. For example, the user may be provided with the image of a face captured by the rear-facing camera(s) 120, one at a time in the case of multiple faces being identified. The user may be able to eliminate the face from the set of potential threats in real-time. That is, the image of the face may be retained until the wearable AR device 10 is powered off. Alternately, the user may upload images of faces offline and eliminate those as potential threats. Whether designated in real-time or offline, the processing circuitry 130 may use the eliminated images in the check at 540.

At 540, a check is done of whether there is a potential SSA threat. This check may be reached if the fixation duration of the user's eye gaze (determined at 520) exceeds a threshold duration and the gaze of one or more faces detected in images of the rear-facing camera(s) 120 (at 530) overlaps the gaze of the user at the time that the fixation duration exceeds the threshold duration. Overlap in gaze may be determined based on the gaze of one or more detected faces being within a threshold distance value from the gaze of the user (during the time that the user's gaze is in the same approximate area for more than a threshold duration). Optionally, the one or more faces detected in images of the rear-facing camera(s) 120 may be compared with images designated by the user as not being a threat before proceeding with the check.

If the check at 540 indicates a potential SSA threat (i.e., fixation duration of the user's eye gaze exceeds a threshold duration and overlaps the gaze of one or more faces detected in images of the rear-facing camera(s) 120, at least one of which is not designated by the user as not being a threat), an alert may be provided to the user at 550. As noted with reference to 527, the alert may be visual (e.g., AR content overlaid on one or more lenses 115, 215), audible, haptic, or a combination of these. An exemplary visual alert 220 may include an arrow indicating a direction of the potential SSA, as shown in FIG. 2.

If the check at 540 indicates that there is no potential SSA threat, the process of obtaining images (at 510) may continue. The processes at 520, 530, optionally 535, and 540 may be repeated periodically, for example. Alternately, the processes at 520 may be performed for each set of images obtained by the camera(s) 110 and rear-facing camera(s) 120, and the detection of a person (at 520) in images obtained with the rear-facing camera(s) 120 may trigger the processes at 530, optionally 535, and 540.

For purposes of detecting potential SSA, images from two or more rear-facing cameras 120 may be processed separately. For example, the same person may be detected by two rear-facing cameras 120 if the person is in an overlap of their fields of view 410. The determination of the person as a potential SSA threat based on one or both of the cameras 120 has the same effect (i.e., alert at 550) and the separate processing may act as a double-check. Alternately, image stitching may be implemented to obtain a single rear-facing image based on images from two or more rear-facing cameras 120. The approach taken may depend on the processing circuitry 130 available in the wearable AR device 10. For example, if parallel processing of images is facilitated, images from rear-facing cameras 120 may be processed separately.

FIG. 6 is a block diagram detailing aspects of the processing circuitry 130 of a wearable AR device 10 (e.g., AR headset 100, AR glasses 200) according to various embodiments. The processing circuitry 130 may be implemented as a server or any other system providing computing capability or may employ a plurality of computing devices arranged, for example, in one or more server banks, computer banks, or other arrangements. The components of the processing circuitry 130 discussed herein and otherwise known to be included are not limited to a specific number of geographic location or proximity relative to other components. For example, the processing circuitry 130 may include a plurality of computing devices that together may comprise a hosted computing resource, a grid computing resource, and/or any other distributed computing arrangement. In some cases, the processing circuitry 130 may correspond to an elastic computing resource where the allotted capacity of processing, network, storage, or other computing-related resources may vary over time.

The processing circuitry 130 may include one or more processors 610 and memory 620, including computer-readable media 620a to store instructions that are processed by one or more of the processors 610 and one or more databases 620b to store data. Computer-readable instructions should be understood as including software generated using programming languages such as, for example, C, C++, C #, Objective C, Java®, JavaScript®, Perl, PHP, Visual Basic®, Python®, Ruby, Flash®, or other programming languages. The processing circuitry 130 may also include communication components 630 to facilitate wireless and/or wired communication via the processing circuitry 130. For example, the user may wirelessly upload images of people designated as not being a threat (at 535, FIG. 5).

Components of processing circuitry 130 may communicate via any known local interface 640 (e.g., a data bus with an accompanying address/control bus or other bus structure). As previously noted, the components are not limited to being arranged or housed together. Thus, wireless and/or wired communication may be employed among the components of the processing circuitry (e.g., local interface 640 may be implemented as a network).

Any reference to processor 610 should be understood to mean one or more of the processors 610 (implemented sequentially or in parallel), and any reference to processor 610 should be understood to refer to the same, different, or a combination of the same and different processors 610 as other references to processor 610.

One or more processors 610 may comprise technologies that include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Memory 620 is defined herein as including both volatile and nonvolatile memory and data storage components. Volatile components are those that do not retain data values upon loss of power. Nonvolatile components are those that retain data upon a loss of power. Thus, the memory 620 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device. In the context of the present disclosure, a computer-readable medium is memory 620 that can be any medium that can contain, store, or maintain the logic or application described herein for use by or in connection with the processing circuitry 130.

As previously noted, the processing circuitry 130 may implement processes (e.g., of the method 500 discussed with reference to FIG. 5) and may provide an alert to the user as overlaid content on one or both lenses 115, 215 of the wearable AR device 10. According to some embodiments, the processing circuitry 130 may include one or more output components 650 (e.g., speaker(s), vibrator) to additionally or alternately provide an audio or haptic alert to the user. In addition, the processing circuitry 130 may facilitate selection (e.g., SSA detection, detection of a person following, detection of a vehicle following) via a user interface 660 in the form of buttons or another known input. For example, the user may designate an image as not belonging to a potential SSA threat in real-time (at 535, FIG. 5) by pushing a button within a specified duration or selecting from one of two buttons.

The features, structures, or characteristics described above may be combined in one or more embodiments in any suitable manner, and the features discussed in the various embodiments are interchangeable, if possible. In the description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed without deviating from the scope of the disclosure or the spirit of the claims. In other instances, well-known structures, materials, or operations are not shown or described in detail to avoid obscuring aspects of the present disclosure.

Terms such as “approximately,” “substantially,” or “about” may be used to account for minor variations in values, relative positions (e.g., substantially parallel or perpendicular), or other descriptors. The amount of variation may be defined by tolerances (e.g., manufacturing tolerances) or conventions understood by those of ordinary skill in the art pertinent to the disclosure. When relative terms such as “on,” “below,” “upper,” “lower,” “front,” “back,” and “rear” are used in the specification to describe the relative relationship of one component to another component, these terms are used in this specification for convenience only, for example, as a direction in relation to an orientation shown in the drawings. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is understood as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, and at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

Therefore, the following is claimed:

1. A wearable augmented reality (AR) device comprising:
one or more cameras positioned to obtain first images of eyes of a user of the wearable AR device;
one or more rear-facing cameras positioned to obtain second images behind the user; and
processing circuitry configured to:
track a gaze of the user based on the first images from the one or more cameras;
determine a gaze of a potential shoulder surfing attack (SSA) threat based on the second images from the one or more rear-facing cameras;
determine whether there is an overlap in the gaze of the user and the gaze of the potential SSA threat; and
provide an alert to the user based on determining that there is the overlap.

2. The wearable AR device according to claim 1, wherein
the wearable AR device is an AR headset; and
the one or more rear-facing cameras comprises one rear-facing camera affixed to a headband of the AR headset.

3. The wearable AR device according to claim 2, wherein the one rear-facing camera is a wide-angle camera with a field of view covering an angular width of at least 80 degrees.

4. The wearable AR device according to claim 1, wherein
the wearable AR device is AR glasses; and
the one or more rear-facing cameras comprises a first rear-facing camera affixed to one of two temples of the AR glasses and a second rear-facing camera affixed to another temple of the AR glasses.

5. The wearable AR device according to claim 4, wherein fields of view of the first rear-facing camera and the second rear-facing camera overlap and cover an angular width of at least 80 degrees.

6. The wearable AR device according to claim 1, wherein the processing circuitry is configured to implement visual simultaneous localization and mapping (SLAM) processes on the first images from the one or more cameras and on the second images from the one or more rear-facing cameras to track the gaze of the user and the gaze of the potential SSA threat in a common three-dimensional reference frame.

7. The wearable AR device according to claim 6, wherein the processing circuitry is configured to determine whether there is the overlap in the gaze of the user and the gaze of the potential SSA threat based on a threshold distance.

8. The wearable AR device according to claim 1, wherein the processing circuitry is configured to omit determining whether there is the overlap based on the potential SSA threat being designated as not being a threat by the user.

9. The wearable AR device according to claim 1, wherein the processing circuitry is configured to provide the alert to the user as content overlaid on a lens of the wearable AR device.

10. The wearable AR device according to claim 9, wherein the content comprises an arrow pointing in a direction of the potential SSA threat.

11. A method implemented by a wearable augmented reality (AR) device, the method comprising:
obtaining first images of eyes of a user of the wearable AR device with one or more cameras;
obtaining second images behind the user with one or more rear-facing cameras;
tracking a gaze of the user based on the first images obtained from the one or more cameras;
determining a gaze of a potential shoulder surfing attack (SSA) threat based on the second images obtained from the one or more rear-facing cameras;
determining whether there is an overlap in the gaze of the user and the gaze of the potential SSA threat; and
providing an alert to the user based on determining that there is the overlap.

12. The method according to claim 11, wherein
the wearable AR device is an AR headset; and
obtaining the second images from the one or more rear-facing cameras comprises obtaining the second images from one rear-facing camera affixed to a headband of the AR headset.

13. The method according to claim 12, wherein obtaining the second images from the one rear-facing camera includes obtaining the second images from a wide-angle camera with a field of view covering an angular width of at least 80 degrees.

14. The method according to claim 11, wherein
the wearable AR device is AR glasses; and
obtaining the second images from the one or more rear-facing cameras comprises obtaining the second images from a first rear-facing camera affixed to one of the temples of the AR glasses and a second rear-facing camera affixed to another temple of the AR glasses.

15. The method according to claim 14, wherein fields of view of the first rear-facing camera and the second rear-facing camera overlap and cover an angular width of at least 80 degrees.

16. The method according to claim 11, further comprising implementing visual simultaneous localization and mapping (SLAM) processes on the first images from the one or more cameras and on the second images from the one or more rear-facing cameras to track the gaze of the user and the gaze of the potential SSA threat in a common three-dimensional reference frame.

17. The method according to claim 16, wherein determining whether there is the overlap in the gaze of the user and the gaze of the potential SSA threat is based on a threshold distance.

18. The method according to claim 11, further comprising omitting determining whether there is the overlap based on the potential SSA threat being designated by the user as not being a threat.

19. The method according to claim 11, wherein providing the alert to the user comprises overlaying content on a lens of the wearable AR device.

20. The method according to claim 19, wherein overlaying content comprises overlaying an arrow pointing in a direction of the potential SSA threat.
